(19) United States
(12) Patent Application Publication
(10) Pub. No.: US 2026/0312095 A1
(43) Pub. Date: Oct. 8, 2026

(54) DETECTION METHOD FOR DETECTING A STATE OF A FUEL CELL SYSTEM

(71) Applicant: Robert Bosch GmbH, Stuttgart (DE)

(72) Inventors: Timo Bosch, Renningen (DE); Christophe Billmann, Stuttgart (DE); Tobias Falkenau, Esslingen (DE)

(21) Appl. No.: 19/108,212

(22) PCT Filed: Sep. 13, 2023
(86) PCT No.: PCT/EP2023/075126

§ 371 Date: Mar. 3, 2025

(30) Foreign Application Priority Data
Sep. 14, 2022 (DE) 10 2022 209 601.0

(51) Int. Cl. H01M 8/04746; H01M 8/0438; H01M 8/0444; H01M 8/04537

(52) U.S. Cl. CPC H01M 8/04761; H01M 8/04388; H01M 8/04447; H01M 8/04597

(57) ABSTRACT

The present invention relates to a detection method (100) for detecting a state of a fuel cell system (200) comprising a first water separator (201) and a second water separator (203), wherein the first water separator (201) is a main water separator of the fuel cell system (200) and has a main outlet valve (207) for discharging water out of the first water separator (201), wherein the second water separator (205) is integrated into a gas conveyor unit (209) of the fuel cell system (200) and has a flushing valve (211) for flushing the fuel cell system (200), and wherein the first water separator (201) has a greater storage volume than the second water separator (203),
wherein the detection method (100) comprises the following steps:
   opening (101) the main outlet valve (207),
   operating (103) the flushing valve (211) at regular intervals while the main outlet valve (207) is open,
   carrying out (105) an empty state detection,
   outputting (107) a notification, according to which a water store of the second water separator (203) is empty, if an empty state is repeatedly detected by the empty state detection during the regular interval operation.

### BACKGROUND

The present invention relates to a detection method for detecting a state of a fuel cell system and a fuel cell system according to the disclosure.

Fuel cells convert hydrogen and oxygen to water, generating electricity that can be supplied to a consumer, such as an electric motor, in order to drive it.

Specific moisture separators are used to separate liquid water from the gaseous portion of the anode exhaust gas. In addition to the separation function, the moisture separator also has the task of storing the separated water. If the accumulator is full, the water is discharged by opening a so-called drain valve.

According to the prior art, fresh hydrogen is supplied to the fuel cell system by means of hydrogen metering valves, which can be designed as proportional valves. The control strategy provides that this valve be used to regulate the gas pressure within an anode path, measured by a pressure sensor at a defined position, to a defined target pressure depending on the system operating point. It may be necessary to feed additional fresh hydrogen due to a) consumption of H2 by the electrochemical conversion b) other losses of gas molecules from the anode chamber, e.g. due to opening the drain valve for too long when gas is discharged after complete water drainage and by opening a so-called flushing valve. Unnecessary activation of the flushing valve costs fuel and, if necessary, additional energy demand for providing dilution air.

If a fuel cell system has two water reservoirs, such as a main water separator and a gas conveyor unit, both function as a drain valve and one additionally assumes the task of a flushing valve.

A hydrogen concentration sensor is located downstream in the waste gas path of the cathode air of the inlet points of the drain valve and the flushing valve. When anode gas reaches the waste gas path of the cathode air, this is detected by the hydrogen concentration sensor.

Methods for detecting a full state of the water reservoirs are known in the prior art. These detect a quasi-overflow of the water separators, but not which of the two water reservoirs is affected.

As a rule, the water reservoir of the gas conveyor unit is smaller than the water reservoir of the main water separator, as the gas conveyor unit separates much less water than the main water separator and the flushing valve is integrated into the gas conveyor unit. Furthermore, due to frequent activation of the flushing valve, the water reservoir of the gas conveyor unit is typically more often in an empty state than the water reservoir of the main water separator, and therefore overflows less frequently or is less often in a full state.

### SUMMARY

Presented in the context of the invention are a detection method for detecting a state of a fuel cell system and a fuel cell system. Further features and details of the invention arise from the disclosure, the description, and the drawings. In this context, features and details described in connection with the detection method according to the invention clearly also apply in connection with the fuel cell system according to the invention, and respectively vice versa, so that mutual reference to the individual considerations of the invention always is or can be made with respect to the disclosure.

The invention presented serves to operate a fuel cell system in a fuel-efficient manner. In particular, the present invention serves to detect an empty state of water separators of a fuel cell system having a plurality of water separators.

Therefore, according to a first aspect of the present invention, a detection method for detecting a state of a fuel cell system is presented, wherein the fuel cell system comprises a first water separator and a second water separator, the first water separator is a main water separator of the fuel cell system and has a main outlet valve for discharging water out of the second water separator, the second water separator is integrated into a gas conveyor unit of the fuel cell system and has a flushing valve for flushing the fuel cell system, and wherein the first water separator has a greater storage volume than the second water separator.

The detection method includes opening the main outlet valve, operating the flushing valve at regular intervals while the main outlet valve is open, carrying out an empty state detection, and outputting a notification, according to which a water store of the second water separator is empty, if an empty state is repeatedly detected using an empty state detection during the regular interval operation.

In the context of the invention presented, an empty state detection is to be understood as a process in which it is determined whether a water separator is empty, i.e. whether there is no water in a water reservoir of the water separator.

In the context of the invention, regular interval operation of a valve is to be understood as operation of a valve in which the valve is opened and closed several times in a short period of time. A frequency at which the valve is opened and closed again can be between 1 Hz and 25 Hz.

The present detection method is based on regular interval operation of a flushing valve of a fuel cell system while a main outlet valve of the fuel cell system is open. As a result of the regular interval operation, operating parameters of the fuel cell system, which may be evaluated by an empty state detection, such as a pressure present in a cathode subsystem, a hydrogen concentration present in the waste gas path of the cathode air downstream of the inlet points of the drain valve and the flushing valve or a consumption of electrical current by a gas conveyor unit of the fuel cell system in the event that a water reservoir of the gas conveyor unit is empty, repeatedly, such that a corresponding signal response of corresponding sensors for detecting the pressure, the hydrogen concentration or the consumed electrical current changes as a function of the regular interval operation and the second water separator can be reliably associated an “empty” state.

As only the flushing valve of the second water separator is operated in the regular interval operation, a corresponding clocked signal response can be associated with the second water separator, such that a state of the second water separator can be detected independent of a state of the first water separator.

It may be provided that the flushing valve is closed and the main outlet valve remains open until a further empty state is detected if an empty state is repeatedly detected by the empty state detection during the regular interval operation.

Closing the flushing valve while the main outlet valve remains open may interrupt hydrogen escaping out of the flushing valve and conserve fuel accordingly.

By opening the main outlet valve until a further empty state is detected, i.e. an empty state is detected after the flushing valve has been closed, the first water separator may be further emptied, as it is usually fuller or needs to drain more water than the second water separator.

It may further be provided that the notification comprises that a water store of the first water separator is also empty and the main outlet valve is closed if an empty state is detected after the flushing valve is closed, in particular directly after the flushing valve is closed.

As a result of an empty state detection carried out after the flushing valve has been closed and the main outlet valve is still open, a state of the first water separator or the main water separator may be reliably detected and the main outlet valve adjusted accordingly.

If an empty state is detected directly after the flushing valve is closed, it may be assumed that the first water separator and the second water separator have emptied at the same time.

It may further be provided that the detection method comprises outputting a notification, according to which a water store of the first water separator is empty, if an empty state is continuously detected by the empty state detection during the regular interval operation.

If an empty state is continuously detected during the regular interval operation, the cause of respective signal changes that resulted in a detection of a “empty” state is not in the second water separator, as signal changes do not occur at regular intervals but must have their cause in the state of the first water separator. Accordingly, it may be assumed that the first water separator is empty and the second water separator still contains water.

It may further be provided that when an empty state is continuously detected by the empty state detection during the regular interval operation, the main outlet valve is closed and the flushing valve is permanently opened until another empty state is detected.

Since it can be assumed that the first water separator is empty if an empty state is continuously detected by the empty state detection during the regular interval operation, the main drain valve can be closed. Since it can further be assumed that the second water separator is still filled with water, the flushing valve must remain open.

It may further be provided that the empty state detection includes determining a pressure present in an anode subsystem of the fuel cell system by a pressure sensor and reporting a detected empty state when measured values determined by the pressure sensor drop below a predetermined pressure threshold value in a predetermined time period after the flushing valve and/or the main outlet valve have been opened.

Since opening the flushing valve or the main outlet valve results in a pressure change in an anode subsystem of a respective fuel cell system, an evaluation of a pressure profile has been found to be a reliable measure of an empty state detection.

It may further be provided that the empty state detection comprises determining a hydrogen concentration in the fuel cell system by means of a hydrogen concentration sensor and reporting a detected empty state if the determined hydrogen concentration is above a predetermined hydrogen concentration threshold value in a predetermined time period after opening the flushing valve and/or the main outlet valve.

As opening the flushing valve or main outlet valve results in an increase in the hydrogen concentration in the waste gas path of the cathode air downstream of the inlet points of the drain valve and the flushing valve of a respective fuel cell system, an evaluation of a hydrogen concentration profile has been found to be a reliable measure of an empty state detection.

It may further be provided that empty state detection includes determining an electrical current consumed by a hydrogen metering valve of the fuel cell system and reporting a detected empty state if the determined electrical current is above a predetermined current threshold value in a predetermined time period after opening the flushing valve and/or the main outlet valve.

As opening the flushing valve or main outlet valve results in a feed of additional hydrogen through a hydrogen metering valve of a respective fuel cell system, an evaluation of an electrical current consumed by the hydrogen metering valve as a measure of activity of the hydrogen metering valve has been found to be a reliable measure of an empty state detection.

According to a second aspect, the presented invention relates to a fuel cell system. The present fuel cell system comprises a first water separator, a second water separator, and a computing unit,
wherein the first water separator is a main water separator of the fuel cell system and has a main outlet valve for discharging water out of the fuel cell system, wherein the second water separator is integrated into a gas conveyor unit of the fuel cell system and has a flushing valve for flushing the fuel cell system, and wherein the first water separator has a greater storage volume than the second water separator. The computing unit is configured to perform a possible configuration of the presented detection method.

In the context of the invention presented, a computing unit is understood to mean a computer, a processor, a control device, or any other programmable circuit.

It may be provided that that the computing unit is configured to output an opening command for opening the main outlet valve, output an activation command that enables operation of the flushing valve in a regular interval mode while the main outlet valve is open, output an activation command to activate an empty state detection while the regular interval mode is enabled, and output a message according to which a water store of the second water separator is empty if an empty state is detected by the empty state detection while the regular interval mode is active.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

Shown are:

FIG. 1 one possible embodiment of the method presented,

FIG. 2 one possible embodiment of the presented fuel cell system.

### DETAILED DESCRIPTION

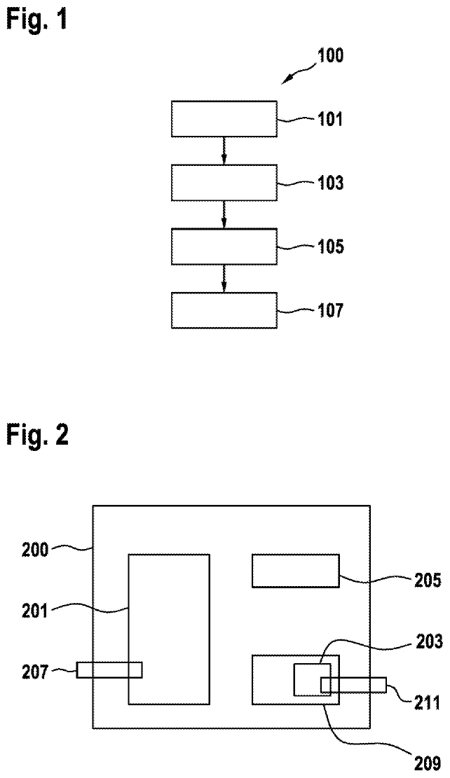

FIG. 1 shows a detection method 100. The detection method 100 for detecting a state of a fuel cell system, wherein the fuel cell system comprises a first water separator and a second water separator, the first water separator is a main water separator of the fuel cell system and a main outlet valve for discharging water out of the second water separator, the second water separator is integrated into a gas conveyor unit of the fuel cell system, and a flushing valve for flushing the fuel cell system, and wherein the first water separator has a greater storage volume than the second water separator.

The detection method 100 includes an opening step 101 in which the main outlet valve is opened, an operation step 103 in which the flushing valve is operated in a regular interval operation while the main outlet valve is open.

Furthermore, the detection method 100 includes an execution step 105 in which an empty state detection is carried out and an output step 107 in which a notification is output according to which a water store of the second water separator is empty if an empty state is repeatedly detected by an empty state detection during the regular interval operation.

FIG. 2 shows a fuel cell system 200. The fuel cell system 200 comprises a first water separator 201, a second water separator 203, and a computing unit 205.

The first water separator 201 is a main water separator of the fuel cell system 200 and has a main outlet valve 207 for discharging water out of the first water separator 201.

The second water separator 203 is integrated into a gas conveyor unit 209 of the fuel cell system 200 and has a flushing valve 211 for flushing the fuel cell system 200.

The first water separator 201 has a greater storage volume than the second water separator 203.

The computing unit 205 is configured to carry out the detection method 100.

1. A detection method (100) for detecting a state of a fuel cell system (200) comprising a first water separator (201) and a second water separator (203),
wherein the first water separator (201) is a main water separator of the fuel cell system (200) and has a main outlet valve (207) for discharging water out of the first water separator (201),
wherein the second water separator (205) is integrated into a gas conveyor unit (209) of the fuel cell system (200) and has a flushing valve (211) for flushing the fuel cell system (200), and
wherein the first water separator (201) has a greater storage volume than the second water separator (203),
wherein the detection method (100) comprises the following steps:
opening (101) the main outlet valve (207),
operating (103) the flushing valve (211) at regular intervals while the main outlet valve (207) is open,
carrying out (105) an empty state detection,
outputting (107) a notification, according to which a water store of the second water separator (203) is empty, if an empty state is repeatedly detected by the empty state detection during the regular interval operation.

2. The detection method (100) according to claim 1,
wherein
the flushing valve (211) is closed and the main outlet valve (207) remains open until a further empty state is detected if an empty state is repeatedly detected by the empty state detection during the regular interval operation.

3. The detection method (100) according to claim 2,
wherein
the notification comprises that a water store of the first water separator (201) is also empty and the main outlet valve (207) is closed if an empty state is detected after the flushing valve (211) is closed.

4. The detection method (100) according to claim 1,
wherein
the detection method (100) further comprises:
outputting a notification, according to which a water store of the first water separator (201) is empty, if an empty state is continuously detected by the empty state detection during the regular interval operation.

5. The detection method (100) according to claim 4,
wherein
when an empty state is continuously detected by the empty state detection during the regular interval operation, the main outlet valve (207) is closed and the flushing valve (211) is permanently opened until another empty state is detected.

6. The detection method (100) according to claim 1,
wherein
the empty state detection comprises:
determining a pressure present in an anode subsystem of the fuel cell system (200) by a pressure sensor,
reporting a detected empty state if measured values determined by the pressure sensor drop below a predetermined pressure threshold value in a predetermined time period after opening the flushing valve and/or the main outlet valve (207).

7. The detection method (100) according to claim 1,
wherein
the empty state detection comprises:
determining a hydrogen concentration in the fuel cell system (200) by a hydrogen concentration sensor,
reporting a detected empty state if the determined hydrogen concentration is above a predetermined hydrogen concentration threshold value in a predetermined time period after opening the flushing valve (211) and/or the main outlet valve (207).

8. The detection method (100) according to claim 1,
wherein
the empty state detection comprises:
determining an electrical current consumed by a hydrogen metering valve of the fuel cell system (200),
reporting a detected empty state if the determined electrical current is above a predetermined current threshold value in a predetermined time period after opening the flushing valve (211) and/or the main outlet valve (207).

9. A fuel cell system (200),
wherein the fuel cell system (200) comprises the following:
a first water separator (201),
a second water separator (203),
a computing unit (205),
wherein the first water separator (201) is a main water separator of the fuel cell system (200) and comprises a main outlet valve for discharging water from the fuel cell system (200),
wherein the second water separator is integrated into a gas conveyor unit (209) of the fuel cell system (200) and has a flushing valve (211) for flushing the fuel cell system (200), and
wherein the first water separator (201) has a greater storage volume than the second water separator (203),
wherein the computing unit (205) is configured to carry out a detection method (100) according to claim 1.

10. The fuel cell system (200) according to claim 9,
wherein
the computing unit (205) is configured to:
output an opening command for opening the main outlet valve (207),
output an activation command that enables operation of the flushing valve (211) in a regular interval mode while the main outlet valve (207) is open,
output an activation command for activating an empty state detection while the regular interval mode is enabled,
output a message according to which a water store of the second water separator (203) is empty if an empty state is detected by the empty state detection while the regular interval mode is active.
